(19) United States
(12) Patent Application Publication
(10) Pub. No.: US 2006/0042286 A1
(43) Pub. Date: Mar. 2, 2006

(54) Stationary vehicle air conditioning system

(75) Inventors: Arthur Heberle, Mannheim (DE); Marcus Weinbrenner, Stuttgart (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Behr GmbH & Co. KG, Stuttgart (DE)

(21) Appl. No.: 11/108,019

(22) Filed: Apr. 15, 2005

(30) Foreign Application Priority Data
Sep. 1, 2004 (DE) 10 2004 042 678.3

(51) Int. Cl. F25B 31/00; F25B 27/00; B60H 1/32; F25B 1/10

(52) U.S. Cl. 62/239; 62/236; 62/510

(57) ABSTRACT

The invention pertains to a stationary vehicle air conditioning system with a refrigerant circuit. The refrigerant circuit can be selectively separated into a plurality of refrigerant sub-circuits through the operation of one or more control valves, thereby permitting optimal efficiency of the stationary vehicle air condition systems during the normal mode or operation and the stationary mode of operation

### CROSS-REFERENCE TO RELATED APPLICATIONS

This patent application claims the benefit of German Patent Application No. DE 10 2004 042 678.3, filed Sep. 1, 2004, which is hereby incorporated by reference.

### FIELD OF THE INVENTION

The invention pertains to a vehicle air conditioning system and method, and more particularly, to an air conditioning system that is particularly advantageous for use with a vehicle in which the engine is not running (a “stationary vehicle”). The invention may be employed, for example, with a truck having a first air conditioner in the driver's compartment and a second air conditioner in a sleeping compartment. The air conditioning system and method includes a plurality of components that may be operated in a first mode while the engine is running and in a second mode while the engine is not running.

### BACKGROUND OF THE INVENTION

German patent application DE 44 14 547 A1 describes a stationary vehicle air conditioning system in which the vehicle engine mechanically drives a first compressor and a DC electric motor powered by auxiliary vehicle batteries electrically drives a second compressor connected in parallel thereto. In normal operation, i.e., with the engine running, the first compressor circulates the refrigerant in the refrigerant circuit without the assistance of the second compressor, and, in stationary operation, i.e., with the engine off, the second compressor circulates the refrigerant without the assistance of the first compressor. The cooling of the refrigerant in each case takes place in a condenser arranged downstream of the junction of the two branches. This arrangement of components does not permit the systems to operate in an optimal manner.

Other types of stationary air conditioning systems with a cold storage unit are also known in the art, but such cooling systems typically require an undesirable charging time. There is thus a need for a stationary air conditioning system that permits the components to operate in a more optimal manner and without an undesirable charging time.

### BRIEF SUMMARY OF THE INVENTION

A stationary vehicle air conditioning system with a refrigerant circuit is provided. The circuit includes at least one compressor to circulate refrigerant within the circuit. The compressor may be driven with an electrical or a mechanical source or may be a hybrid type that accepts either an electrical or mechanical source. An air cooled condenser for cooling the refrigerant coming from the compressor is also arranged in the circuit. The refrigerant circuit may be switched into a plurality of separate refrigerant sub-circuits, wherein the plurality of sub-circuits enables an optimization of the compression characteristics for given vehicle operating states.

In a preferred embodiment, the refrigerant circuit includes a front air conditioner arranged in one sub-circuit and a rear air conditioner in the other sub-circuit, the two being independently regulated. Each sub-circuit preferably includes a compressor. In connection with an appropriate collection of valves and operating states, one of the compressors selectively circulates refrigerant in the entire refrigerant circuit in a first mode of operation. A second compressor, which is preferably inactive in a first mode of operation, circulates refrigerant in the second sub-circuit. The second compressor is preferably an electrically driven compressor, which is preferably driven only in a second mode of operation.

In a preferred embodiment of the invention, the compressor associated with the entire refrigerant circuit and/or a front air conditioner is driven mechanically with the aid of the vehicle's engine, e.g., through a belt connected to a rotating engine part. The compressor can be selected from a group consisting of a mechanically-driven compressor, an electrically driven compressor, and a hybrid compressor that can be driven both by the vehicle's engine and electrically.

The two refrigerant sub-circuits preferably are separated by valves the change position when the vehicle's engine is running (“normal” operation) or stopped (“stationary” operation. The connection of the two refrigerant sub-circuits to form an overall circuit preferably takes place during the return from stationary operation to normal operation. A separation makes sense because markedly lower cooling power is required in stationary operation than in normal operation, which is why the corresponding compressor or compressors also can be smaller than the counterpart compressors required to supply refrigerant during normal operation. This also applies to a hybrid compressor, whose mechanical drive power is preferably larger than its electrical drive power.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a simplified representation of a refrigerant circuit according to a first embodiment;

FIG. 2 is a simplified representation of a refrigerant circuit according to a second embodiment;

FIG. 3 is a simplified representation of a refrigerant circuit according to a third embodiment;

FIG. 4 is a simplified representation of a refrigerant circuit according to a fourth embodiment; and

FIG. 5 is a simplified representation of a refrigerant circuit according to a fifth embodiment.

### DETAILED DESCRIPTION OF THE INVENTION

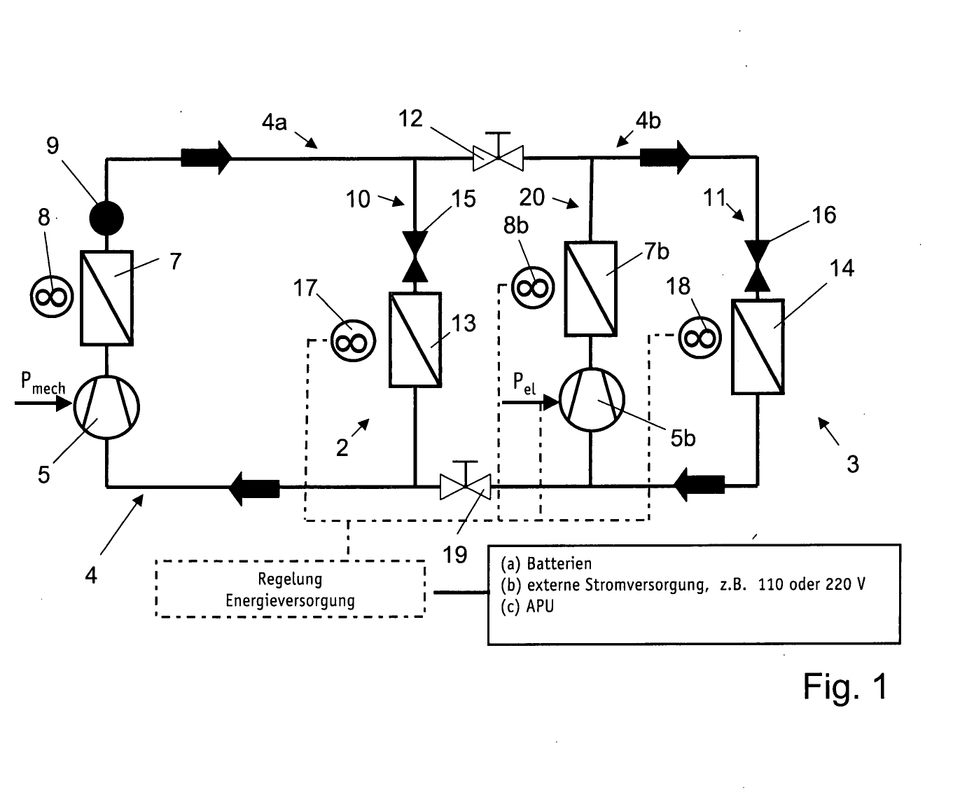

FIG. 1 illustrates a vehicle air conditioning system 1 with a front air conditioner 2 and a rear air conditioner 3 includes a refrigerant circuit 4. A vehicle air conditioning system 1 according to the invention as in one of the embodiments described below can preferably be used in a truck with an area such as a sleeping compartment that is separate from the driver's compartment, with front air conditioner 2 being located in the driver's compartment and a rear air conditioner 3 in a separate area of the vehicle.

A belt driven first compressor 5, which is powered by the vehicle engine, circulates refrigerant through circuit 4 in a normal operating mode, i.e., while the engine is running. In a stationary operating mode, i.e., with the motor stopped, the first compressor likewise is stopped, and a second compressor 6 is driven electrically by means of batteries or an external (AC) power source or an auxiliary power unit (APU). The electric power source is indicated in all figures with dashed lines.

The flow of refrigerant through circuit 4 in “normal” operation, i.e., with the vehicle's engine running, will be described first. Appropriate sensors, switches and control logic (not shown) detect the vehicle and/or engine operating mode and select the position of valves 12 and 19, which are capable of cutting off refrigerant flow through portions of circuit 4 in a manner described below. In normal operation, valves 12 and 19 are open, and compressor 5 drives refrigerant through a condenser 7 that is cooled by a vehicle-engine driven fan 8. Condenser 7 may be further cooled by wind or by an air stream generated through the motion of the vehicle. Downstream of condenser 7, a receiver 9 collects and temporarily stores excess liquid refrigerant.

Due to the open state of valves 12 and 19, refrigerant flowing through circuit 4 thereafter splits into two branches 10 and 11, which branches are associated respectively with air conditioners 2 and 3. Before refrigerant reaches a respective evaporator 13 or 14, it flows through an expansion member 15 or 16, respectively, in which it is expanded and thereby cooled down. Associated with each evaporator 13 and 14 is an electrically driven fan 17 and 18, which conveys air through evaporators 13 and 14 and into the vehicle's interior in the respective climate control zone. After flowing through evaporators 13 and 14, the refrigerant streams are reunited and go back to first compressor 5 in normal operation.

In stationary operation, i.e., with the vehicle's engine stopped, refrigerant circuit 4 is divided into two refrigerant sub-circuits 4a and 4b through the operation of first valve 12 and a second valve 19, which are closed. Compressor 5, which is driven by the vehicle engine, is inactive in the first refrigerant sub-circuit 4a associated with front air conditioner 2, and there is no circulation of the coolant in this sub-circuit during stationary operation in this embodiment.

An electrically drivable compressor 5b circulates refrigerant through sub-circuit 4b, which is associated with rear air conditioner 3, and particularly, through downstream condenser 7b arranged in branch 20. The refrigerant branches off downstream of valve 12 as viewed in the flow direction in normal operation and returns upstream of valve 19. Second compressor 5b can be driven via batteries or an external (AC) power source or an auxiliary power unit (APU) and, in a preferred embodiment, is supplied with power exclusively in the stationary mode of operation. Air conveyed by an electrically drivable fan 8b flows through condenser 7b in order to cool down refrigerant circulated through the sub-circuit 4b. In normal operation, that is, when refrigerant is not made to flow through branch 20, however, compressor 5b and fan 8b are inactive. In order to prevent a backflow of refrigerant via branch 20, a check valve (not shown) is provided in branch 20. The refrigerant subsequently reaches branch 11, where it is decompressed in expansion member 16 and further passed through evaporator 14. Air conveyed by fan 18 flows provides an air stream for evaporator 14.

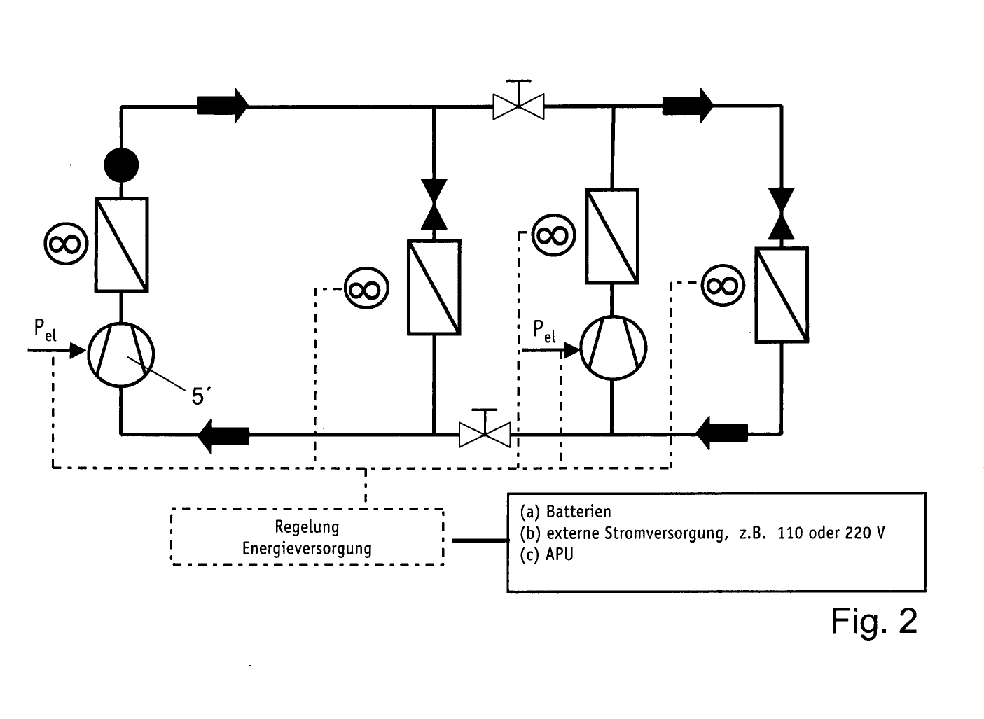

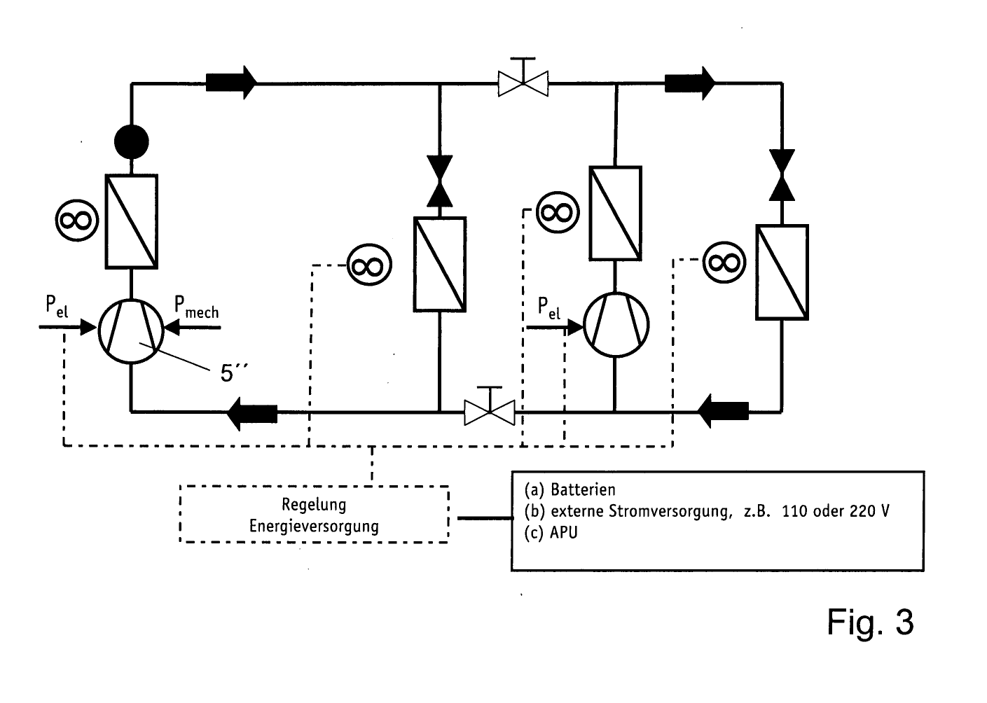

FIG. 2 illustrates an alternative embodiment of the invention in which the mechanically driven compressor 5 is replaced with an electrically driven compressor 5′. This substitution provides for the circulation of refrigerant in the first sub-circuit 4a in a stationary mode of operation. In addition, according not shown in FIG. 2, two compressors also can be arranged in parallel branches of the first refrigerant sub-circuit, so that a first and mechanically drivable compressor can be designed for the entire refrigerant circuit during normal operation and the second and electrically drivable compressor circulates refrigerant trough sub-circuit 4a during stationary operation. As with prior embodiments, to prevent backflow when one of the compressors is inactive, a check valve is arranged in the appropriate branch of the refrigerant circuit. FIG. 3 illustrates yet another embodiment of the invention. In this embodiment, a hybrid compressor 5″ circulates refrigerant through circuit 4. Hybrid compressor 5″ is driven mechanically by the vehicle engine in normal operation and electrically in stationary operation.

Based on the foregoing description of certain preferred embodiments, persons of skill in the art will appreciate other regulation systems in regard to normal and stationary operation, such as two refrigerant circuits circulated with the aid of two compressors with a partial exchange of refrigerant in certain operating states. Likewise, an exclusive circulation of refrigerant by electrically drivable compressor 5b in stationary operation would also be possible, with part of the refrigerant flowing through valve 12 to branch 10 and through valve 19 back to compressor 5b.

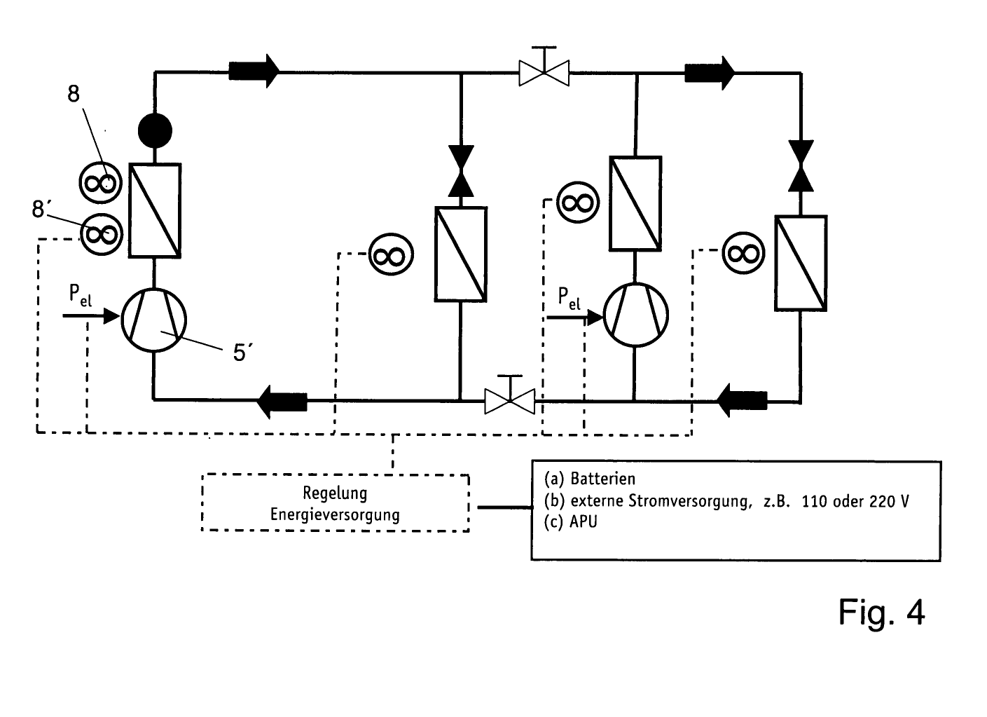

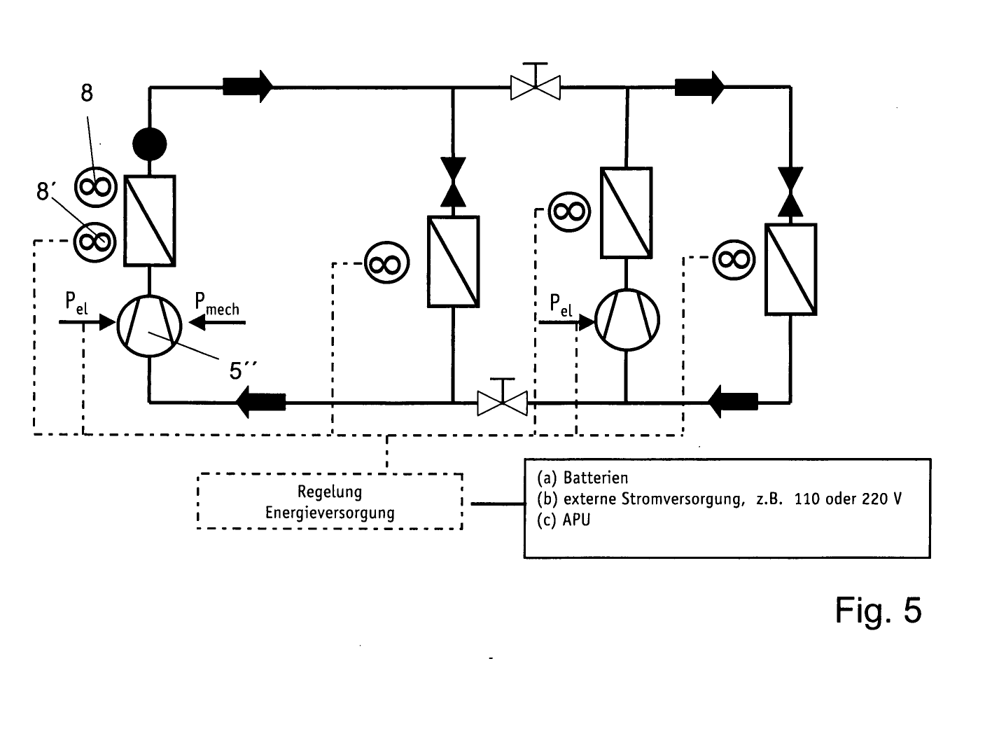

FIG. 4 illustrates an embodiment of the invention that is similar in certain respects to the prior embodiments. In this embodiment, however, a second and electrically drivable fan 8′ is located proximate to mechanically driven first fan 8. This second fan provides an air stream to further transfer of heat from the condenser 7, particularly during stationary operation. FIG. 5 likewise illustrates a dual fan configuration to supply air to condenser 7. In the embodiment of FIG. 5, however, the compressor in the first sub-circuit is a hybrid type, which may be driven electrically or mechanically.xxx

It is noted that in certain embodiments of the invention, refrigerant flows through parallel connected compressors, condensers or evaporators. In these types of arrangements, refrigerant tends to accumulate in certain components during stationary operation. In particular, a parallel connected and inoperative compressor can accumulate an undesirably high amount of excess refrigerant, which can in turn lead to a drop in cooling power, and, under certain circumstances, to a failure of the compressors. This failure mode may be caused, at least in part, by the fact that the same amount of refrigerant exists in both the stationary and engine-running modes of operation. Because a smaller amount of refrigerant is typically required in stationary mode, due to the lower cooling needs, it may be necessary to take further appropriate measures to reduce the amount of refrigerant during stationary operation. This may be accomplished, for example, by drawing off a predetermined amount of refrigerant via a bypass (not shown) and temporarily storing this refrigerant in an accumulator (not shown) during stationary operation. After normal operation is resumed, the stored refrigerant may be pumped back into the refrigerant circuit.

As an alternative to the previously-described embodiments, a refrigerant receiver with variable capacity is deployed in the refrigerant circuit. It is also possible to integrate an expansion member into a receiver and to add a drier unit, so that corresponding combinations are provided in place of the two expansion members of the first embodiment. As yet an additional alternative, a bypass with an ice accumulator may be located in the refrigerant circuit, into which bypass the excess (cold) refrigerant is directed, the brine is cooled, and the refrigerant remains in this bypass during stationary operation. In some or all of the foregoing embodiments and alternatives to such embodiments, at least a portion of a condenser that is inactive during stationary operation can serve for interim storage of the excess refrigerant. Likewise, in some or all of the foregoing embodiments and alternative embodiments, a hybrid drive unit can be provided for one fan, which replaces the two fans for the previously described embodiments in which two differently drivable fans are provided at one condenser.

According to yet other alternative embodiments, a plurality of condensers may be connected in series. Such condensers may be “hard-wired” in series or selectively placed in series depending upon the operating characteristics desired. In additional, the refrigerant circuit 4 may include a plurality of fans, one or more of which is associated a condenser. The fans supplied in the refrigerant circuit 4 may be electrically and/or mechanically drivable. Finally, and again depending on desired operating characteristics, one or more bypass sub-circuits may be included in the refrigerant circuit. Such bypass sub-circuits, through the use of appropriate sensors, switches and control logic, may selectively reroute refrigerant around one or more condensers in order to increase the efficiency of the overall circuit. Typcially, a bypass sub-circuit is desirable where the circumvented condenser is inactive during a particular operating mode.

In order to optimize the air flow in fluid dynamic terms, in place of two differently drivable fans at one condenser, a hybrid drive unit can be provided for one fan, which replaces the two fans.

While this invention has been described with an emphasis upon particular embodiments, it should be understood that the foregoing description has been limited to the presently contemplated best modes for practicing the invention. It will be apparent that further modifications may be made to the invention, and that some or all of the advantages of the invention may be obtained. Also, the invention is not intended to require each of the above-described features and aspects or combinations thereof. In many instances, certain features and aspects are not essential for practicing other features and aspects. The invention should only be limited by the appended claims and equivalents thereof, since the claims are intended to cover other variations and modifications even though not within their literal scope.

What is claimed is:

1. An air conditioning system for use in a vehicle and having air conditioning elements positioned within a refrigeration circuit, wherein the air conditioning system operates in a first operating mode when a mechanically linked vehicle engine is running and in a second operating mode when the engine is stopped, the air conditioning system comprising a selectively operable first compressor, a first condenser positioned downstream of the first compressor and a plurality of control valves, wherein the refrigeration circuit may be selectively separated into a plurality of sub-circuits through the operation of the control valves.

2. The air conditioning system of claim 1, wherein a first air conditioner is arranged in a first refrigerant sub-circuit and a second air conditioner is arranged in a second refrigerant sub-circuit.

3. The air conditioning system of claim 2, wherein the first air conditioner is a front air conditioner and the second air conditioner is a rear air conditioner.

4. The air conditioning system of claim 1, wherein each refrigerant sub-circuit includes a refrigerant compressor.

5. The air conditioning system of claim 1, wherein the selectively operable compressor is driven mechanically with the aid of the vehicle engine.

6. The air conditioning system of claim 1, wherein the selectively operable compressor is a hybrid compressor that is selectively driven by either a mechanical power source or an electrical power source.

7. The air conditioning system of claim 1, wherein a least one refrigerant sub-circuit includes an electrically drivable compressor.

8. A method for operating an air conditioning system with a refrigerant circuit, wherein the air conditioning system operates in a first operating mode when a mechanically linked vehicle engine is running and in a second operating mode when the engine is stopped, the method comprising the steps of circulating refrigerant through the circuit during the first operating mode and separating the circuit into a plurality of refrigerant sub-circuits during the second operating mode by closing a plurality of valves.

9. The method of operating an air conditioning system according to claim 8, further comprising the step of combining the plurality of sub-circuits into a circuit when the air condition system switches from the second operating mode to the first operating mode.

10. The method of operating an air conditioning system according to claim 8, wherein a compressor circulates refrigerant in at least one of the sub-circuits during the second operating mode.

11. The method of operating an air conditioning system according to claim 9, wherein no refrigerant is circulated in at least one of the sub-circuits during the second operating mode.
